(19) United States
(12) Patent Application Publication
(10) Pub. No.: US 2008/0020787 A1
(43) Pub. Date: Jan. 24, 2008

(54) Mobile Station

(76) Inventor: Jari Lahtinen, Vantaa (FI)

Correspondence Address: CERMAK KENEALY & VAIDYA LLP, 515 E. BRADDOCK RD, SUITE B, ALEXANDRIA, VA, 22314, US

(21) Appl. No.: 11/628,773

(22) PCT Filed: Jun. 7, 2005
(86) PCT No.: PCT/FI05/00266

§ 371 Date: Apr. 27, 2007

(30) Foreign Application Priority Data
Jun. 7, 2004 (FI) 20040780

(51) Int. Cl. H04Q 7/32; H04M 1/02

(52) U.S. Cl. 455/466

(57) ABSTRACT

The invention relates to a mobile station and a method for sending messages from a mobile station to a recipient. A mobile station according to the invention comprises means for creating a message and means for defining the recipient of the message. The mobile station further comprises processing means for identifying the type of a message and selecting the sending manner and format of a message according to the type of the message. The type of a message can be, for example, an audio message, text message, picture message, electronic mail message, video message or multimedia message. The mobile station further comprises sending means for forming a connection and sending a message from the mobile station to the mobile station operator.

### FIELD OF THE INVENTION

The invention relates to a mobile station and a method for sending messages from a mobile station to a recipient.

### BACKGROUND OF THE INVENTION

When making a telephone call or sending a text message by mobile telephone, the telephone number of the recipient is selected either by keystrokes or by selecting a number stored in the telephone.

On the other hand, when sending an electronic mail by mobile telephone, a call is made first to the server of the mobile telephone operator and the user logs on to an Internet page and then from there to his own mobile electronic mail server using personal passwords.

The method is slow and cumbersome and requires many actions before even achieving the situation, from which the actual writing and sending of an electronic mail begins.

Additionally, the method requires that the line between the mobile telephone and the mobile telephone operator must also be open while the message is being written. This causes additional expenses to mobile phone users.

For writing text messages and electronic mail, letter functions combined with the number keyboard of the mobile telephone are used, whose use is noticeably slower than, for example, the use of the keyboard of a computer in the writing of electronic mail messages. When writing a message a user must perform possibly many strokes per key to achieve the letter desired, for example, to achieve the letter L a user must press the same key 3 times.

As one solution to make writing easier, the so-called communicator has been developed, containing under an openable cover a keyboard nearly comparable to that of a PC. However, this solution requires increasing the size of the mobile station, which is not always desirable on the part of the user.

As yet another alternative in the solution of prior art, a separate keyboard for speeding up the writing of text messages or similar messages has been developed. In this case, each letter has its own key in the separate keyboard. This solution requires that the separate part in question is carried along, which is required by the relatively fast writing of messages.

### SUMMARY OF THE INVENTION

An object of the invention is to obviate or at least mitigate the aforementioned disadvantages and to provide a mobile station and a system, with which electronic mail messages can more easily and more cost-efficiently be written and sent by mobile station.

An object of the invention is to provide a method for the faster and easier sending of messages, in particular electronic mail messages, by mobile station, and a mobile station suitable for this purpose.

An object of the invention is to provide a more cost-efficient method for sending messages sent by mobile station, and a mobile station suitable for this purpose.

These objects are achieved by a mobile station and a method, which are presented in the independent claims. A mobile station and a method according to the invention are characterized in what is presented in the characterizing portion of the independent claims.

The dependent claims present additional characteristics of embodiments of a mobile station and a method according to the invention.

By using the invention, significant advantages in solutions of prior art are achieved. The fact that the message is defined in the mobile station prior to the opening of a connection between the mobile station and the mobile telephone operator, i.e. that a connection does not need to be open as the message is defined, saves on expense for users of mobile stations. Additionally, a mobile station with multi-function keys increases the speed of writing messages. The use of an electronic mail address for defining the recipient in the sending of all types of messages removes the need for using and also for remembering telephone numbers.

Other advantages of the invention are presented in the detailed description of the invention.

### BRIEF DESCRIPTION OF THE DRAWINGS

In the following, the invention and its preferred means of implementation are described in detail, by way of example, with reference to the accompanying drawings, in which:

FIG. 1A shows as a flowchart a sending process according to a preferred embodiment of the invention,

FIG. 1B shows as a flowchart a transmission and receiving process according to a preferred embodiment of the invention,

FIG. 2 shows a mobile station according to one embodiment of the invention.

### DETAILED DESCRIPTION OF THE INVETION

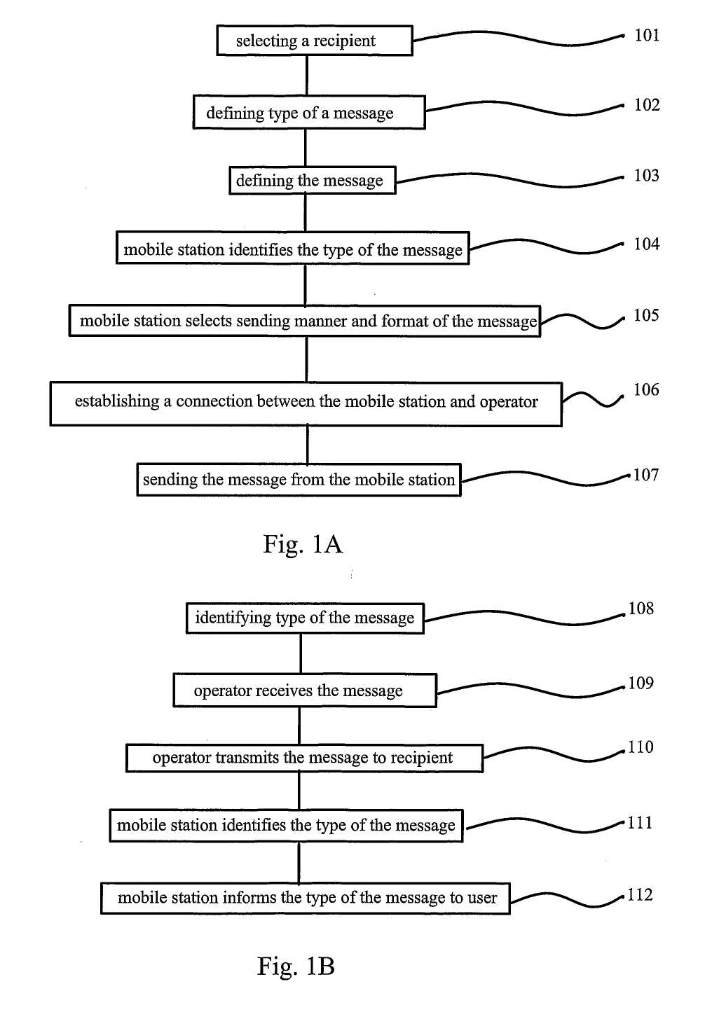

FIG. 1A shows as a flowchart a sending process according to a preferred embodiment of the invention.

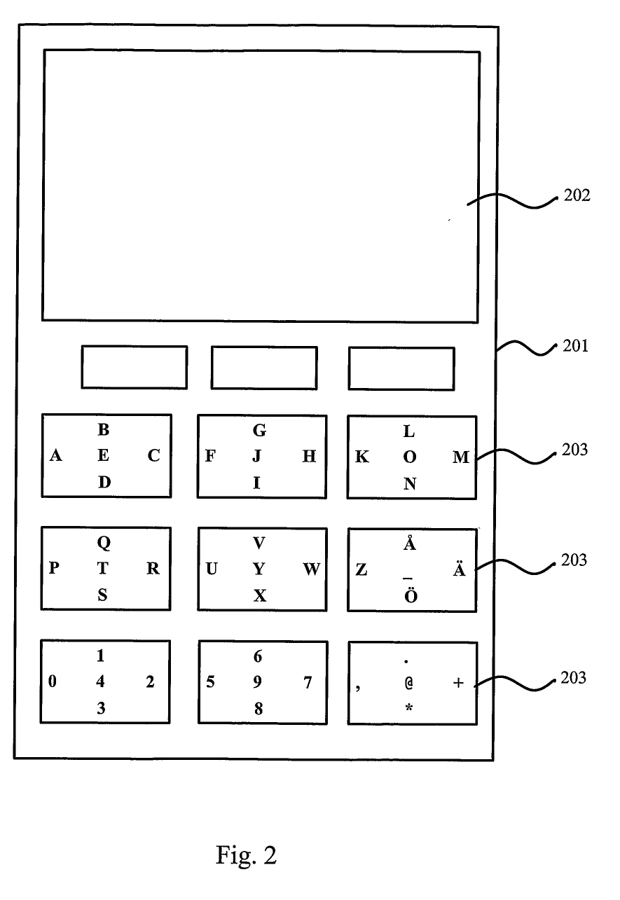

A mobile station (a mobile telephone) according to the invention is built and programmed such that using keys or audio frequency selection the electronic mail address of an individual is selected, stage 101. A keyboard according to the invention is preferably a keyboard based on letter characters for speeding up the writing of messages. A keyboard according to one embodiment of the invention is presented in the following in more detail with reference to FIG. 2.

After this, the user of the mobile station defines the type of the message, stage 102. The type of the message may be an audio message, text message, electronic mail message, or other type of message (for example picture message or multimedia message). In the event that the mobile station comprises preset selections for different types of messages, the user may use these to define the type of the message. If the mobile station identifies spoken commands, the user may define the type of the message by speaking the command in question to the mobile station. In the case of a mobile station according to the level of the invention, the definition of message type is executed using menus of the mobile station.

In stage 103, the user of the mobile station defines the message that he wishes to send to the predefined recipient of the message. The definition of a message is executed either using the keyboard or, in more developed applications, for example, by dictating to the mobile station the desired message, which the mobile station can thereafter convert into text, if a text message or electronic mail message is defined.

In stage 104, the mobile station identifies the written or spoken message type, according to which the mobile station will thereafter select the sending manner and sending format of the message according to the preset definition, stage 105. The definition of the message as well as the selection of the sending manner and sending format is executed programmatically. In other words, the mobile station contains a program that is capable of identifying the type of a message and selecting its sending manner and sending format according to the message.

In stage 106, a connection is formed between the mobile station and the mobile telephone operator in a manner known per se through the base station of the operator to the network managed by the operator, after which the message is sent from the mobile station to the mobile telephone operator in stage 107. Because a solution according to the invention does not require changes in the mobile telephone network itself (other than program changes in the different devices of the network) and networks of prior art are well known to persons skilled in the art, different possible network alternatives are not described here in greater detail. The protocols used in mobile station networks and similar definitions are described, for example, in the standards of the ITU-T (ITU; International Telecommunication Union).

FIG. 1B shows as a flowchart a transmission and receiving process according to a preferred embodiment of the invention. The base station and the other network devices of the operator are arranged to identify the type of the message according to the alternatives presented above, stage 108. Identification of the message type is executed programmatically in the receiving device. When a packet switched data network is used, a definition of message type can be added to the data packet, based on which the base station or similar network part is capable of identifying the type of the message.

In the next stage, stage 109, the operator receives the message, after which it routes the message, if the type of the message is an electronic mail message, either to the electronic mail address of the recipient, to the server, or alternatively it transmits the message directly to the mobile telephone of the recipient, stage 110. The recipient of the message can define the device receiving the message in advance.

To define the receiving device, the user has informed the mobile telephone centre in advance whether he wishes to receive, for example, electronic mail messages on his mobile station. Another alternative is that that electronic mail messages are routed to the own electronic mail server of the user of the receiving mobile station. One possibility is also that electronic mail messages are routed both to the mobile station and to the electronic mail server of the user of the receiving mobile station, from which the recipient can read the electronic mail message in the ordinary way on his own PC, to which it is also transmitted through a wired or wireless network in the transmission manner of normal electronic mail, for example through a www-connection or as a mobile message from his mobile station.

In one embodiment of the invention, the message is then routed to the recipient according to the type of the message either as an ordinary telephone call, text message or electronic mail message directly to the mobile station. The mobile station of the recipient identifies the type of the message, stage 111, according to the identifier it carries with it and informs the mobile station user of its type in a pre-agreed manner, stage 112. So when, for example, a text message or electronic mail message has arrived, the mobile station of the recipient informs of the arrival of the message either by ringing, audio signal and/or a symbol appearing on the screen.

In the preferred embodiment of the invention, both the connection between the mobile station and the mobile telephone operator and the connection between the mobile telephone operator and the data terminal equipment (mobile station, PC or similar) of the message recipient are based either on the telephone number of the message recipient or on an electronic mail address used as an identifier. The use of an electronic mail address as an identifier also makes it possible that telephone numbers would no longer be needed in the case that the recipient has an electronic mail address based on which messages and/or telephone calls can be routed to a recipient.

According to the preferred embodiment of the invention, the primary function of the keyboard of the mobile station (mobile telephone) is based on letter characters. On this basis, the writing of electronic mail messages is fast and easy compared to solutions according to the level of the invention, because the mobile station is capable of suggesting letter-by-letter previously saved addresses as the initial characters match. And when the correct alternative is found, the selection is made and a request for a connection is sent.

According to the alternate embodiment of the invention, audio selection is used for electronic mail address selection, definition of a message as well as definition of a message type. When audio selection is used, for example, in the selection of an electronic mail address, the mobile station repeats the recipient identification information in adequate detail to avoid mistakes. This repeating of identification information is achieved such that as the electronic mail address is loading the user has dictated both the electronic mail address and the associated personal identification information into the memory of the mobile station, from which the mobile station retrieves information as needed. When defining a message by aid of audio selection, to the mobile station is preloaded a dictation program, which enables the conversion of speech into text, which is later sent to the recipient. Advantageously, the program is also capable of spell-checking. The use of audio selection is particularly advantageous for sight-impaired persons.

A significant advantage of the arrangement described above is that the creation of a currently difficult and slow www-connection occurs under the new arrangement automatically in the server of the mobile telephone operator and the connection between the mobile station and the mobile telephone operator always occurs in the manner of an ordinary telephone call. The connection between the mobile station and the centre is not a www-connection in the present manner. The www-connection occurs between the mobile telephone centre device and the www-server utilizing fast wired arrangements. The mobile station wirelessly sends a digital “message package” to the base station, which then forwards the message to the mobile telephone centre, which interprets the quality of the message and acts accordingly transmitting the message using wired or wireless networks and normal connections to a PC and/or the mobile station or similar device of the recipient. Electronic mail messages between mobile stations would travel as text messages do these days and yet such that the electronic mail message in question also moves in the network utilizing wired connections managed by the mobile telephone operator through fixed connections or using www-protocols. The sending of an electronic mail from a PC would occur in the ordinary manner and upon logging in of the electronic mail message into the electronic mail mailbox of the recipient on the electronic mail server, it would then be forwarded automatically to the mobile station of the recipient through the centre and base stations of the mobile telephone operator.

The embodiment described above may also be utilized in Internet telephone calls. In this case, the user can define either in advance or case-specifically whether the telephone call is routed entirely for transmission by mobile station network transmission or alternatively through the mobile telephone network to the server, from which it is routed through the Internet to the recipient.

The server, to which the message arrives, can be compared, for example, to a mail sorting centre. A message is transmitted in accordance to the wishes of the recipient (as the recipient has predefined to the mobile station operator) either to a mobile telephone, PC, line telephone, where it arrives converted into an audio message, or even though as a transmission through a digital television transmitter to a digital TV receiver.

In the case of a laptop PC, the receiving and sending occurs in a familiar manner utilizing wired or wireless networks.

A significant advantage of this new manner of sending an electronic mail message is that the line between the mobile station and the mobile telephone operator must be engaged only when the message is either being sent or being received, and not as is done at the present time wirelessly through the www, wherein a connection is constantly maintained with the www-server while writing or reading an electronic mail message. The method therefore saves significantly the expenses of the user.

According to one embodiment of the invention, the user of the mobile station first defines the electronic mail address of the recipient, based on which the telephone call or message can be routed to the recipient. After this, the user of the mobile station selects as the type of the message either a real-time sending or the sending of a message. A real-time sending can be, for example, a telephone call or a video phone call. The sending of a message comprises the sending of, for example, an electronic mail message or multimedia message.

If the user of the mobile station wishes to begin a real-time sending, he can select it, for example, by pushing the telephone call button, after which the process described above continues from stage 105. In this case, the above-described stage 104 for defining the message is left out.

If the user of the mobile station wishes to send a message, he then defines the message to be sent either by typing the message and/or by defining the pictures to be sent an/or by defining the audio message.

If the user of the mobile station defines only text as the message, the mobile station automatically identifies the type of the message as a text message, if the text is 160 characters or less in length. If the length of the text is more than 160 characters, the mobile station automatically identifies the message to be sent as an electronic mail message. Also in the event that the user defines an attachment file in addition to text, the mobile station automatically identifies the type of the message as an electronic mail message.

If the user defines as the message only a picture or several pictures, the mobile station identifies the type of the message to be sent as a picture message. In a similar manner, the mobile station identifies the types of messages to be sent automatically, without the user having to define them separately.

After identifying the type of the message, the mobile station selects the sending format according to the above-described stage 105, after which the transmission of the message or telephone call follows the previously described process.

FIG. 2 shows a mobile station according to one embodiment of the invention. A mobile station according to FIG. 2 is letter character-based, with which the speed of writing text messages and/or electronic mail messages can be increased. A mobile station 201 according to FIG. 2 comprises a screen 202 and a keyboard 203.

In the solution according to FIG. 2, each key is multi-functional and can be used to provide 5 different characters. In the design of the keyboard 203 it must be noted that each key is as large as possible in order that many functions can be executed by one key. According to this embodiment of the invention, each key is a so-called rocker key which, when an edge is pressed, selects the character on that edge. In the centre of the key is also one character on each key. One letter fits on each edge and in the centre yet one more, i.e. for a sum of five different functions (in the case of a square- or rectangular-shaped keyboard). Each function is achieved with one keystroke. The arrangement may vary in different variations according to practical requirements, and for this reason the arrangement shown in FIG. 2 should not be considered to be the only possible arrangement.

The key then is advantageously designed such that the design aids in occurrence of the correct function. One preferable embodiment for the design of a key is concave, due to which the selection of different characters is easier.

In one embodiment of the invention, the keys of the mobile station are located on two sides of the mobile station, of which the first keys are located on the first side and the other keys are located on the other side. In this case, the numeric keys are located on one side of the mobile station and the character keys are located on the other side. This embodiment also makes it possible to insert two screens on the mobile station. Of these one screen is preferably larger than the other screen.

Here can be used as a solution the larger screen, which is located on the number keyboard side of the mobile station, for example, for showing picture messages or video messages to the user. The smaller screen is suitable, for example, for showing menus to the user. To protect the screen, for example, protective plates can be added that can be slid over the screen and away as needed. In this manner, even more sensitive screens can be protected from possibly getting dirty or damaged. Alternatively, openable covers can be added to protect the screens.

In this solution the mobile station two pairs of earphones and a microphones can be used. The earphone and microphone pairs can be activated, for example, by identifying in the mobile station, which earphone is in contact with the ear of the user. This can be done, for example, using sensors installed in the mobile station.

To protect the keyboards and screens, openable covers can also be added to one or both sides of the mobile station. In this manner, it is also possible to activate the use of the earphone and microphone by defining, which of the covers of the mobile station is opened.

To the person skilled in the art it is clear that the embodiments described above can be changed and/or modified without departing from the solution according to the invention, which is defined in the accompanying claims. For example, the transfer network for messages described above can be based on any mobile telephone network what-soever, which is capable of transferring the necessary information to transmit the message. In other words, the solution is not tied, for example, to a third generation mobile telephone network. Additionally, for example in the case of a character-based keyboard, the number of characters on a key can be four instead of five. The shape of the keys can also deviate from a rectangular shape, being for example triangular in shape. These variations in the keys are based mainly on comfort of use and industrial design.

1. A mobile station comprising:
means for defining the electronic mail address of the recipient of the message;
means for creating a message;
processing means for identifying the type of a message and selecting the sending manner and format of a message according to the type of the message, wherein the type of a message is one of the following: audio message, text message, picture message, electronic mail message, video message or multimedia message; and
sending means for forming a connection and sending messages from a mobile station to a mobile station operator.

2. A mobile station according to claim 1, wherein the type of a message is identified automatically on the basis of a message defined in the mobile station.

3. A mobile station according to claim 1, wherein the means for creating a message and the means for defining the electronic mail address of the recipient of the message is a keyboard.

4. A mobile station according to claim 3, wherein the keyboard comprises several multi-function keys, each one comprising at least two motion directions, by means of which a character is provided.

5. A mobile station according to claim 4, wherein each key comprises five touch surfaces, which produce different characters.

6. A mobile station according to claim 1, wherein the mobile station further comprises means for defining the type of a message.

7. A mobile station according to claim 6, wherein the mobile station comprises preset selection keys for defining the type of a message.

8. A mobile station according to claim 6, wherein the means for creating a message, means for defining the electronic mail address of the recipient of the message and means for defining the type of a message is data processing means based on audio-guidance.

9. A mobile station according to claim 8, wherein the processing means comprises a program portion for spell-checking a message.

10. A mobile station according to claim 1, wherein the mobile station is a mobile telephone.

11. A mobile station according to claim 1, wherein the processing means is arranged to identify, according to a program installed in the mobile station, the type of a message and select the sending manner and sending format of the message in accordance with the definition of the program.

12. A mobile station according to claim 1, wherein the mobile station further comprises:
receiving means for receiving messages from the mobile station operator; and
means for presenting the message to the user of the mobile station.

13. A mobile station according to claim 12, wherein the means for presenting the message to a user is a mobile station screen.

14. A mobile station according to claim 12, wherein the means for presenting the message to a user is a mobile station speaker.

15. A method for sending messages from a mobile station to a recipient, the method comprising:
defining the electronic mail address of the recipient by the mobile station;
creating the message by the mobile station;
identifying the type of the message automatically by the processing means of the mobile station, wherein the type of the message is one of the following: audio message, text message, picture message, electronic mail message, video message or multimedia message;
selecting by the processing means of the mobile station the sending manner and sending format of the message according to the type of the message;
establishing a connection between the mobile station and the mobile station operator;
sending the message from the mobile station to the mobile station operator;
identifying the type of the message by the network device of the mobile station operator; and
transmitting the message from the mobile station operator to the recipient.

16. A method according to claim 15, wherein the message is created by a keyboard of the mobile station.

17. A method according to claim 15, wherein identification of the type of the message and selection of the sending manner and sending format of the message is executed by the processing means of the mobile station according to the definition of a program installed in the mobile station.

18. A method according to claim 15, wherein the recipient defines in advance, to which receiving device the recipient wishes messages to be sent from the mobile station operator.

19. A method according to claim 15, wherein the connection between the mobile station and the mobile station operator is closed immediately after sending of the message.

20. A method according to claim 15, wherein if the type of the message is an electronic mail message, the mobile station operator transmits the message to the mobile station of the recipient and/or the electronic mail server of the recipient according to a predefined operation.
